(19) United States
(12) Patent Application Publication
(10) Pub. No.: US 2019/0263518 A1
(43) Pub. Date: Aug. 29, 2019

(54) Unmanned Aerial Vehicle Having an Insect Trap

(71) Applicant: Espen Garner, Irvine, CA (US)

(72) Inventor: Espen Garner, Irvine, CA (US)

(21) Appl. No.: 15/908,515

(22) Filed: Feb. 28, 2018

(51) Int. Cl. B64C 39/02; A01M 1/04; A01M 5/02

(52) U.S. Cl. CPC B64C 39/024; A01M 1/04; B64C 2201/12; A01M 2200/012; B64C 2201/024; A01M 5/02

(57) ABSTRACT

Embodiments of unmanned, rotary wing drones are described herein that include an insect trap for luring and capturing mosquitoes or other insects. The drone can include a set of propulsion units, each having a motor and propeller, and that collectively provide sufficient lift when operating to allow the drone to fly. A flight controller can be used to send and receive information and control a flight of the drone according to a flight plan stored on the drone. The insect trap includes a funnel or other mechanism to allow only for one-way movement of an insect into a container. To lure the insect into the trap, ultraviolet light can be shone on high-surface titanium dioxide powder that is stored within a mesh bag. A battery or other power source can be used to power the various components, and solar panels can be used to charge the battery when the drone has landed.

### FIELD OF THE INVENTION

The field of the invention is mobile and autonomous insect traps.

### BACKGROUND

The following description includes information that may be useful in understanding the present invention. It is not an admission that any of the information provided herein is prior art or relevant to the presently claimed invention, or that any publication specifically or implicitly referenced is prior art.

No one is exempt from the bite of a mosquito, and if that mosquito carries a disease, then the insect will pass along the disease and infect a person. The cycle starts with mosquitoes ingesting microorganisms while feeding on an infected person or animal. Later, the pathogens are transmitted into a different person or animal when the female mosquito uses its proboscis to inject saliva before sucking blood from its next victim. Mosquitoes are vectors, or carriers, of many deadly diseases, including Malaria, Dengue and Yellow Fever, West Nile Virus, Chickungunya and Zika virus.

In the past, Zika virus became a widespread epidemic, infecting approximately 3-4 million people, and resulting in microcephaly and other central nervous system malformations in its victims' offspring. The virus even impacted the Olympic Games in Brazil as pregnant women were unable to attend due to the risk of infection. As recently as November 2017, Texas experienced its first case of Zika virus infection spread by local mosquitoes.

However, mosquito populations are often difficult to test, as they are often in remote locations or in confined spaces. This increases the difficult in trapping the mosquitoes due to the terrain, location, and so forth. Traditional traps require physical placement and close monitoring, which can be difficult in less populated areas.

The testing of mosquitoes for viruses has become important for one main reason: virus carrying mosquitoes have become common in our world, sickening hundreds of millions of people annually and killing several million people each year. Currently, the U.S. faces difficulty in efficiently catching the insects responsible for the spread of such viruses. In Orange County alone, there are 24 species of mosquitoes, a handful of which transmit disease. Two new invasive mosquitoes to the Orange County area include the Asian tiger (Aedes albopticus) which transmits Zika and Dengue and Yellow Fever, and Aedes aegypti which mainly transmits Yellow Fever, but can also transmit Zika. Two other dangerous mosquito species are Culex, which transmits West Nile Virus, and Anopheles, which carries the parasite that transmits malaria. With an improved ability to trap mosquitoes for testing, the U.S. would be better able to alert the public if a new risky mosquito populations and mosquitoes that might be carrying viruses into their local area arrived before there is a major health threat. This early detection is critical to prevent mosquitoes from spreading viruses.

Some companies have begun to develop prototypes to locate and trap mosquitoes using unmanned aerial vehicles (UAVs). For example Microsoft has created a UAV that uses artificial intelligence to identify areas where mosquitoes may be present, and where a physical trap may be place. However, this UAV is not only expensive but also lacks an insect trap and is only useful for identifying a specific sampling location.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for an insect trap that allows for remote monitoring and movement.

### SUMMARY OF THE INVENTION

The inventive subject matter provides apparatus, systems and methods in which a lightweight, unmanned aerial vehicle has an insect trap configured to attract and trap mosquitoes or other insects. The UAV is preferably autonomously flown according to a stored flight plan, such that the UAV can take off from a first position, fly to a second position, land, and then take off and return to the first position. The UAV can include a power source sufficient to permit flight to the second position, and have solar panels to recharge the power source to permit the UAV to take the return flight to the first position.

In other embodiments, a lightweight UAV can be used to carry and release genetically modified mosquitoes. The modified mosquitoes would then mate with native mosquitoes, and their progeny could be resistant to spreading disease due to the alteration in genetic material.

Taking the above challenges into consideration, the use of a lightweight UAV carrying a mosquito trap provides an ideal solution to navigating the insect trap into remote locations and confined spaces where it can capture mosquitoes. In addition, an economical UAV and trap would also allow financially strapped government agencies to more readily access mosquitoes for testing.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1A illustrates a perspective view of one embodiment of the UAV in-flight.

FIG. 1B illustrates a top view of the UAV of FIG. 1A.

FIG. 2 illustrates one embodiment of an insect trap for use on a UAV.

FIG. 3 is a chart showing the percentage of mosquitoes captured using different lures.

FIG. 4 is a chart showing a number of mosquitoes captured at different times of day.

FIG. 5 is a chart of potential ranges of a UAV under varying conditions.

FIG. 6 is a chart of solar panel voltages as a function of time of day.

FIG. 7 presents various measurements from a flight of a UAV.

FIG. 8 is a chart of characteristics of the propulsion units at full throttle.

FIG. 9 is a photograph of one embodiment of a lure for an insect trap.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

Unmanned Aerial Vehicles are aircraft with no pilot on board. UAVs can be remotely controlled (e.g. flown by a pilot at a ground control station) or fly autonomously based on pre-programmed flight plans of more complex dynamic automation systems. One type of UAV is a quadcopter, or which has two pairs of rotors (vertically-oriented propellers). One pair of the rotors rotates clockwise, and the other rotates counter clockwise. Flight is controlled by the speed of each rotor. The UAV or drone is typically flown with First Person View (FPV), which means a video camera is mounted on the UAV, broadcasting the live video to the pilot on the ground. This allows the pilot to fly the UAV as if onboard rather than look at the UAV from the pilot's actual ground position.

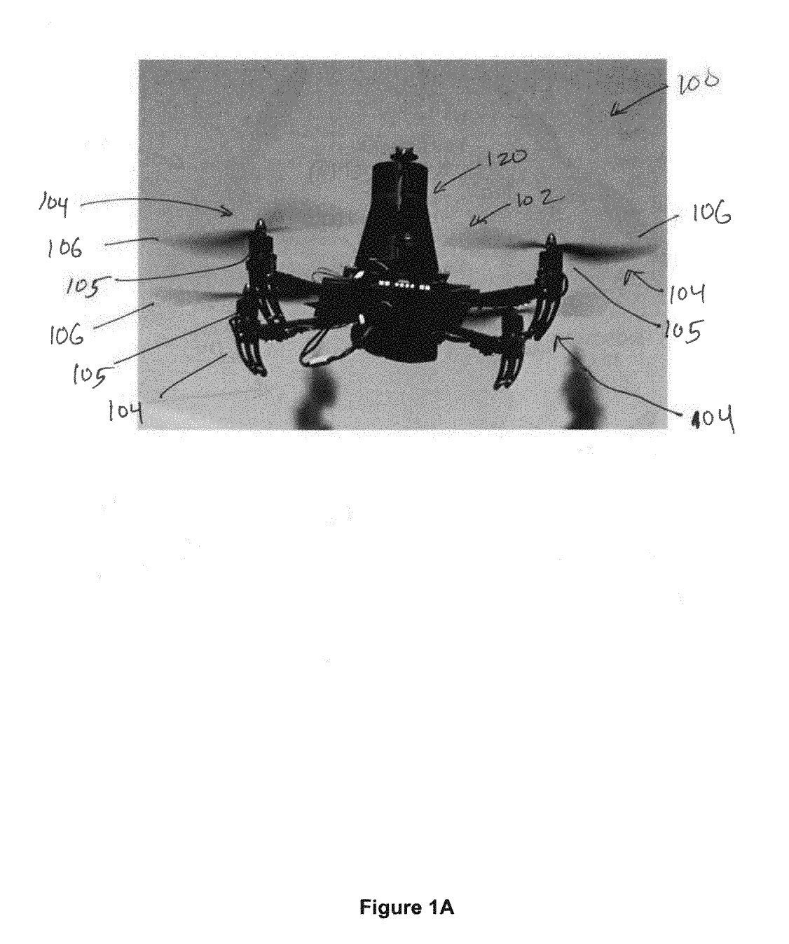

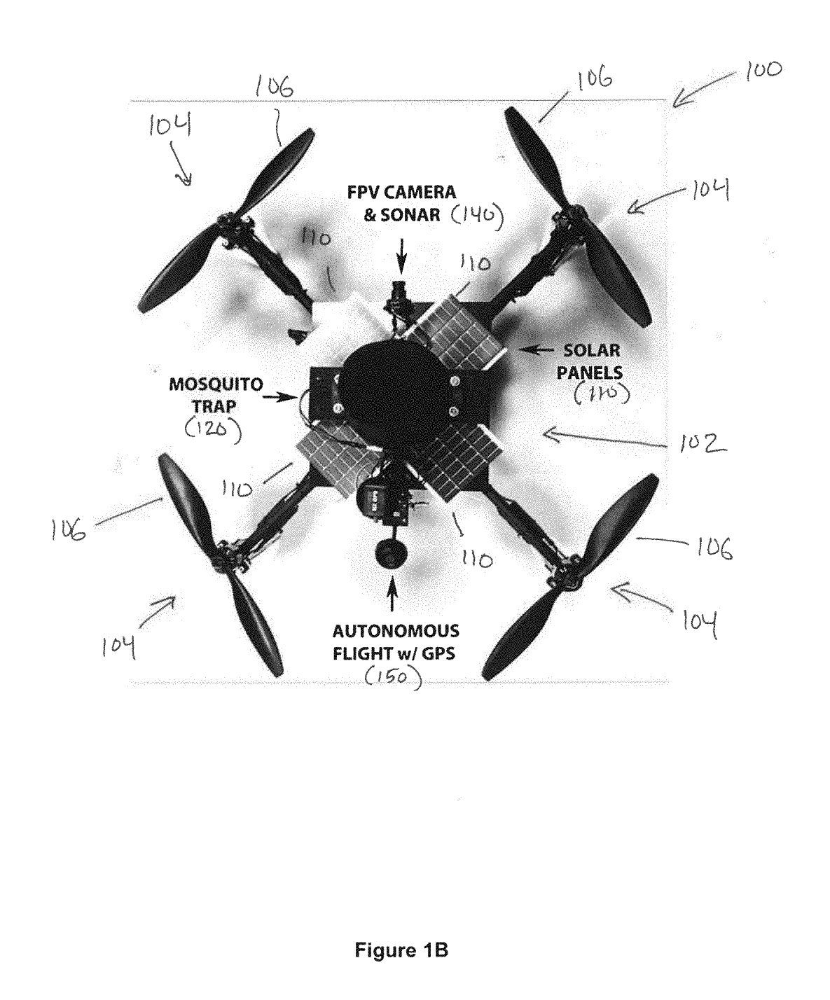

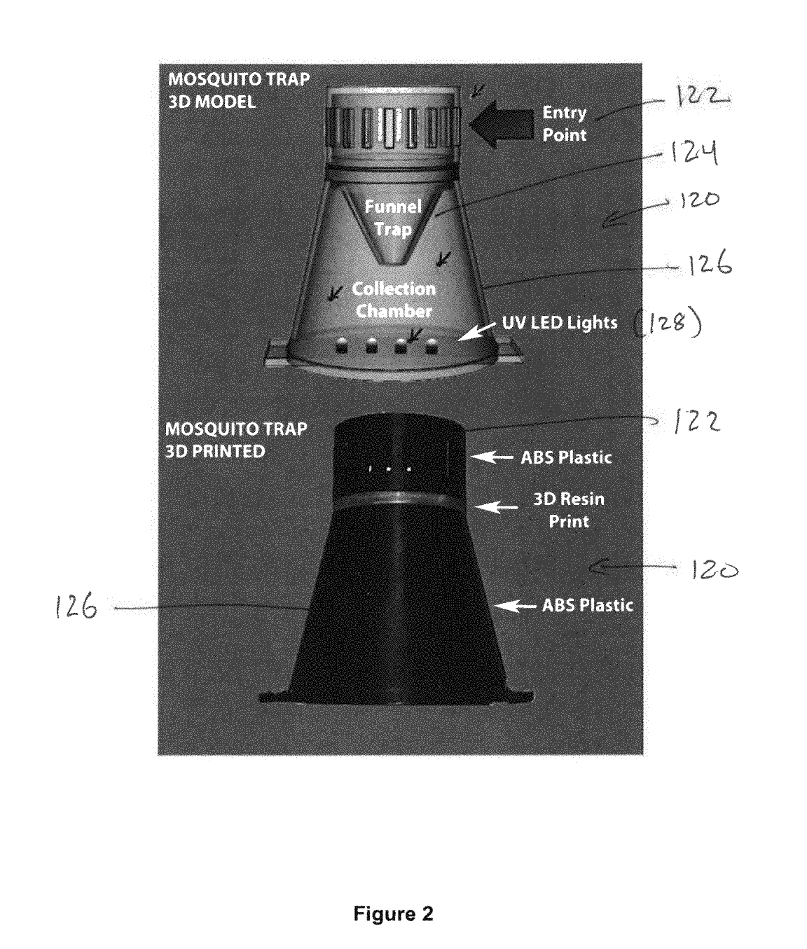

FIGS. 1A-1B and 2 illustrate one embodiment of a rotary wing, unmanned aerial vehicle 100. The UAV 100 has a body 102 with four propulsion units 104, each comprising a variable-speed motor 105 coupled with a propeller 106. The motor 105 and propeller 106 are selected such that rotation of one or more of the propulsion units 104 provides sufficient lift to allow the body 102 and UAV 100 to fly. Preferably, the body 102 has a carbon fiber frame to reduce weight although other commercially suitable materials or combinations thereof could be used.

Where four propulsion units 104 are used, it is preferred that two of the propulsion units are configured to rotate their respective propellers clockwise, with the other two propulsion units configured to rotate their respective propellers counter-clockwise, to thereby allow directional control of the drone by varying the rotational speed of the units.

UAV 100 further comprises a flight controller disposed on the body 102 and that comprises (1) a transmitter/receiver for transmission to and receipt of data from a remote source, and (2) a memory configured to store at least one flight plan. The flight controller is preferably configured to autonomously control the propulsion units 104 as a function of the stored flight plan and fly the UAV 100 from a first, initial position to a second position, all while remotely controlled or in autonomous operation.

The UAV 100 can optionally include a video camera 140 and a GPS unit 150. The video camera 140 can be used to provide a pilot with POV flight control when needed or desired, and in some cases, permit live or recorded view of the surroundings where the UAV 100 has landed. The GPS unit provides updated location information to at least one of the flight controller and a remote pilot to determine the location of the UAV 100 and make any adjustments to the course as needed, for example.

A power source such as a battery is coupled to the body to provide power to the propulsion units 104, the flight controller, and other components on the UAV (UV light sources) that may require power. Preferably, the power source is selected such that the UAV 100 can take-off from a first position, fly a distance of at least one, or at least three, or at least five miles and then land at the second position according to a stored flight plan. Preferably, the power source has a storage capacity of between 4,000-6,000 mAh, although smaller or larger capacities could be used so long as the UAV 100 can meet the above flight requirements. As configured, it is preferred that the UAV 100 will fly past its point of no return (with respect to the power source), such that the power source must be charged at the second position before the UAV 100 can return to the first position.

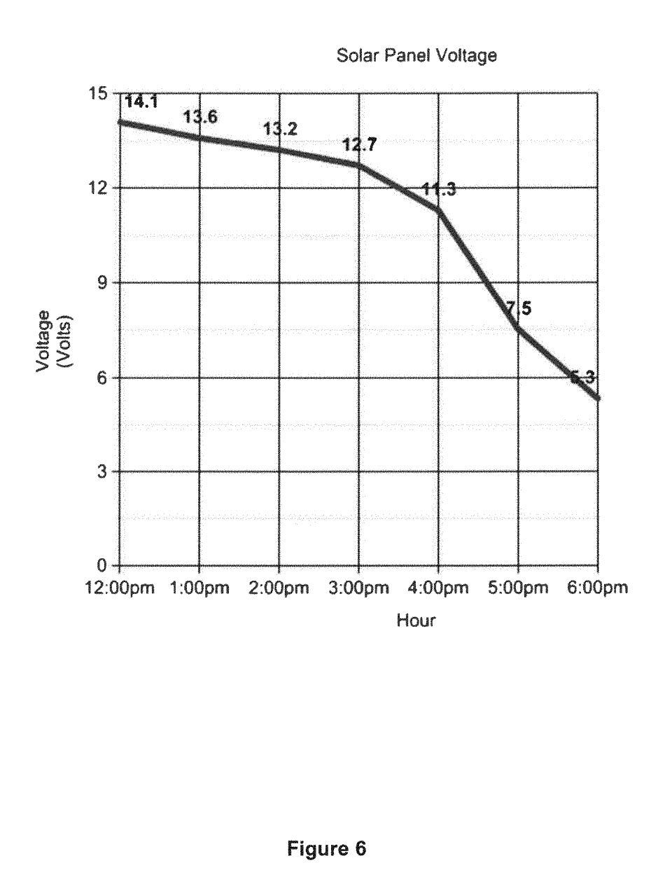

Because the UAV 100 is preferably configured to take off, travel to and land at a destination, and then take off from that destination and return back, all without swapping the power source or other physical interaction with the UAV 100, it is preferred that the UAV 100 has one or more photovoltaic panels 110 that can provide power to and thereby recharge the power source 100 while the UAV 100 is away. FIG. 6 illustrates voltage produced by the photovoltaic panels 110 during an afternoon, with the voltage expectedly decreasing in the later afternoon as compared with high noon.

Without the photovoltaic panels 110, the distance that can be traveled would be limited by the power source used. In addition, it is preferred that the photovoltaic panels 110 are sufficiently sized to permit recharge of the battery to permit the UAV 100 to take off and return to the first position from the second position.

The UAV 100 also has an insect trap 120 coupled to the body 102. The insect trap 120 preferably has an opening or ingress 122 that leads to a funnel 124 placed on a container 126. In some embodiments, the ingress 122 comprises a grate sized and dimensioned to permit entry into the insect trap of the mosquito or other insect, although in other embodiments the ingress could be one or more openings. As will be appreciated, the insect trap can be fabricated in any suitable manner using various materials, including 3D printing of polymers (e.g., BPA/resin), machining of aluminum, etc.

The funnel 124 preferably has an opening at one end that allows only one-way movement of a mosquito or other insect into the container 126 via the funnel 124.

To lure the mosquitoes into the container, the insect trap 120, and specifically the container 126, preferably creates carbon dioxide (CO₂) on demand. Although prior art traps have utilized CO₂ cartridges or other inefficient means of producing CO₂, such traps were not suitable for use in a UAV due to high power requirements (e.g., the use of a fan), high weight (many components), and/or a need for manual replacement of cartridges. While working to address these issues, the inventor discovered that sufficient CO₂ to attract mosquitoes can be produced using at least one very low-power ultraviolet light sources 128, such as ultraviolet LEDs in the mW range when high-surface titanium dioxide (TiO₂) is used.

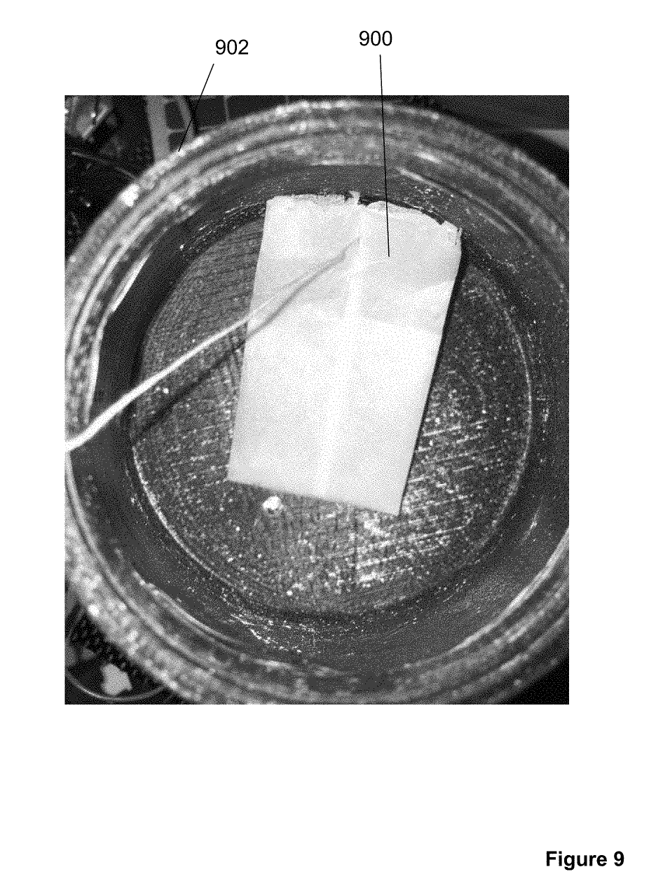

Ordinarily, high-surface material is loose powder of micron/nanosize particles, which would be blown off/away from a UAV during flight or with wind flow. Surprisingly, however, when high-surface TiO₂ powder was contained in a porous thin-walled mesh bag 130 (e.g., a tea bag), the porous nature of the bag 130 permitted sufficient ultraviolet light and ambient organic volatile molecules to interact with the TiO₂ to produce sufficient quantities of CO₂ to attract mosquitoes. An exemplary embodiment of a mesh bag 900 disposed within an insect trap 902 is shown in FIG. 9.

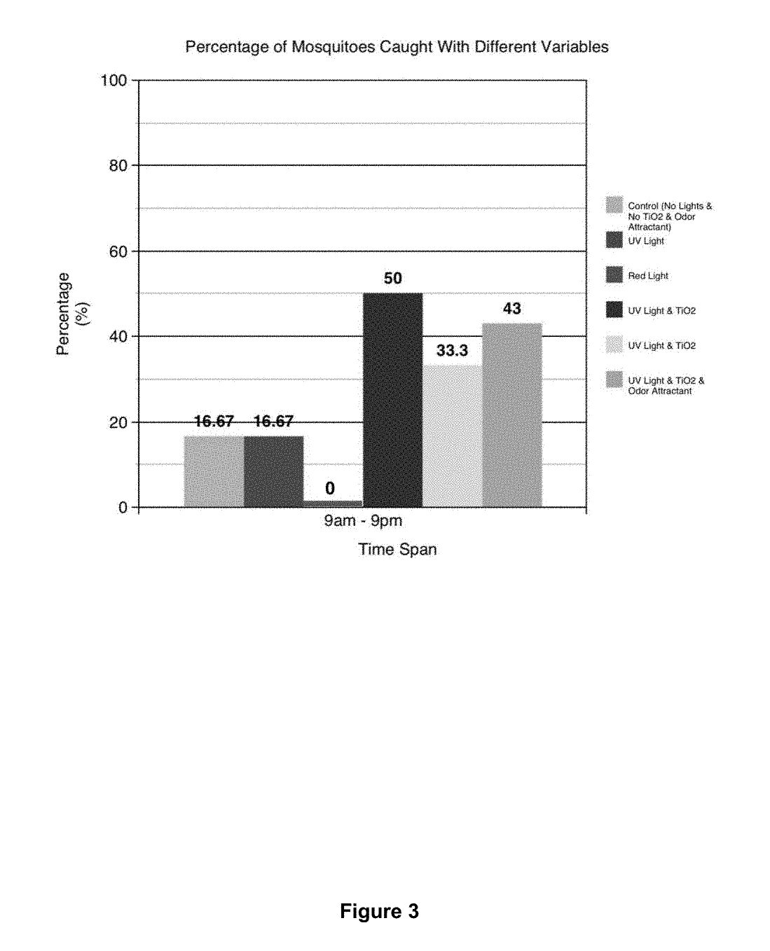

This was proven effective during various tests, in which different combinations of the use of low-power UV lights and TiO₂ were used. As shown in FIG. 3, the combination of low-power UV lights and TiO₂ far outperformed tests using (i) no UV light sources and no TiO₂, (ii) UV light sources but no TiO₂, and (iii) TiO₂ but no UV light sources.

It is contemplated that the UV light source(s) could be powered by the power source and/or the photovoltaic panels 110.

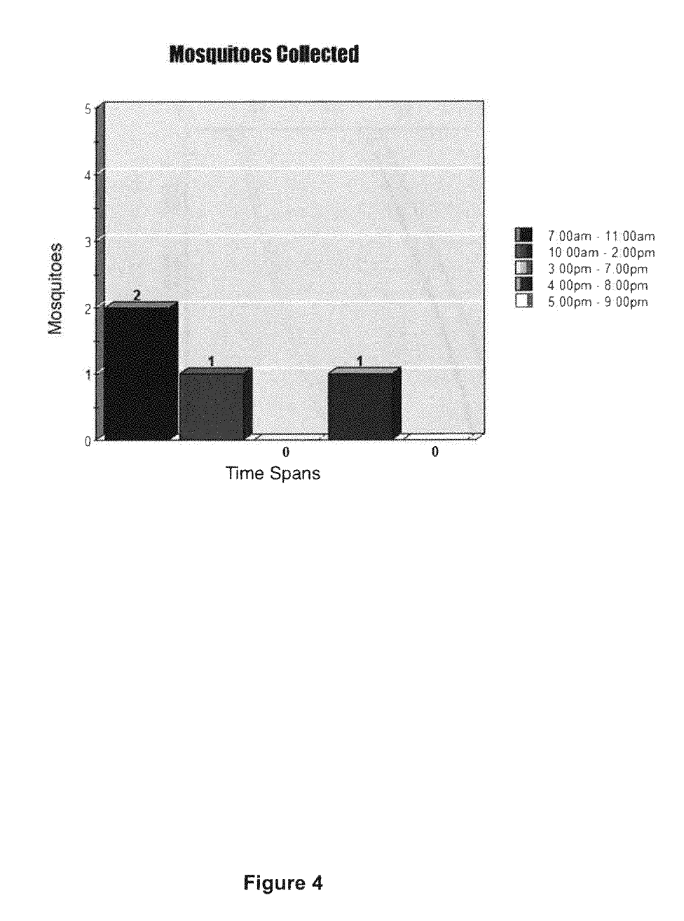

The inventor also tested for time of day to determine whether certain time periods were better for collecting mosquitoes. Based on the results from the limited testing shown in FIG. 4, early morning was found to be best to catch mosquitoes.

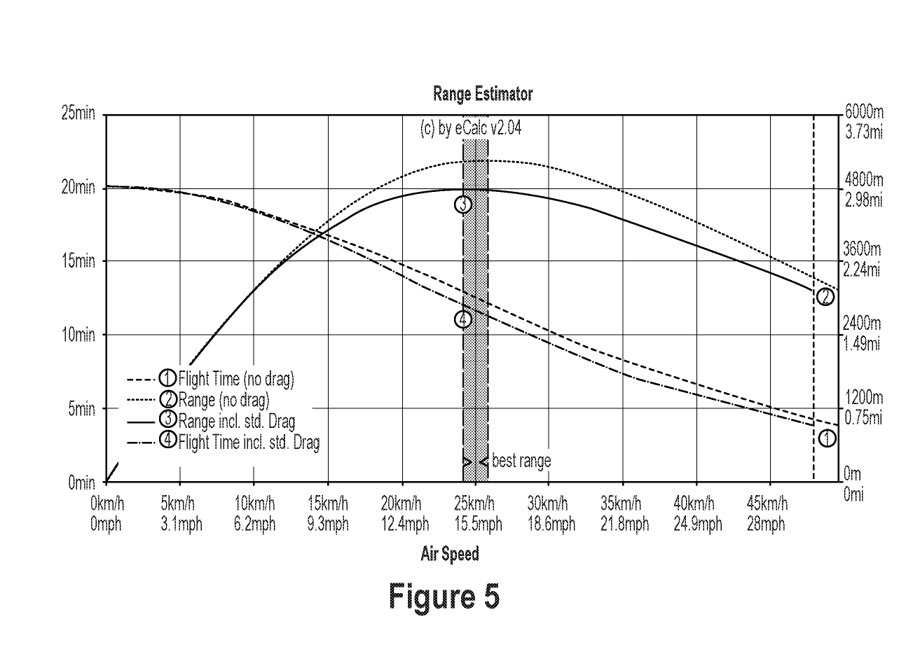

Using a range estimator with the results shown in FIG. 5, the inventor found that the UAV 100 as described above had the best range using an air speed of 25 km/h, although the specific air speed would depend on the final weight of the UAV, the power source, and other factors.

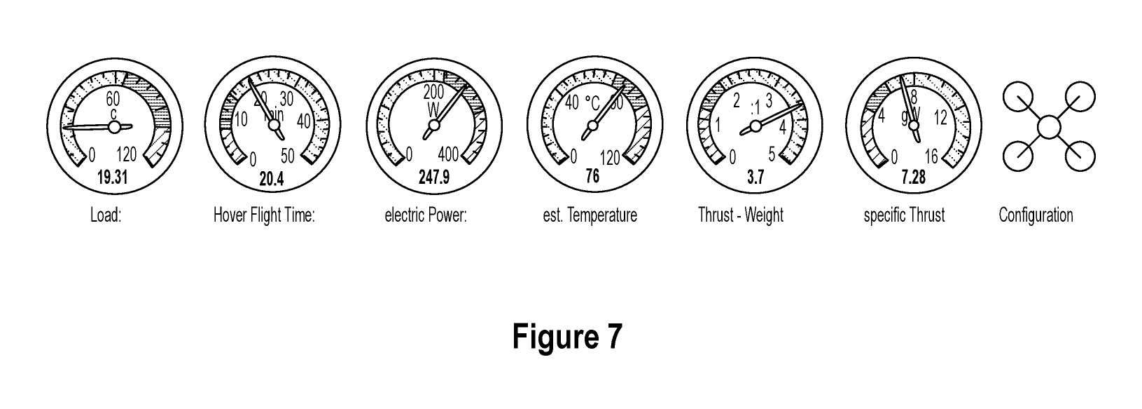

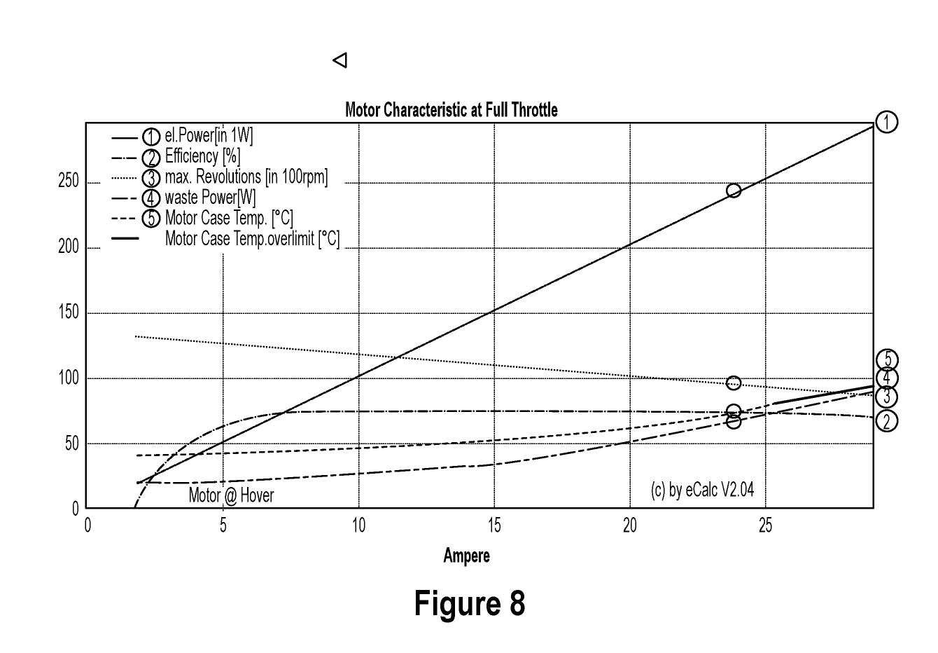

Various measurements from the UAV 100 during a flight are shown in FIG. 7. FIG. 8 presents characteristics of the propulsion units at full throttle.

Although the TiO₂ powder is preferably disposed within the container 126, it is contemplated that the TiO₂ powder could alternatively or additionally be disposed on the funnel 124.

As shown in FIG. 2, the low-power UV light sources 128 can be disposed within the insect trap 120, and preferably below the funnel 124 and within the container 126. However, it is also contemplated that the UV light sources 128 could be disposed outside of the container 126, such as where at least a portion of the container is transparent or translucent to allow UV light to pass through the container's wall.

In testing, the UAV 100 was able to fly to distant locations and utilize its UV light sources to produce CO₂ from the TiO₂ powder. In initial testing, the UAV 100 was calculated to fly approximately 3 miles at a speed of about 15.5 mph.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An unmanned, rotary wing drone having an insect trap, comprising:
a body having one or more propulsion units, each of which include a motor and a propeller, wherein the one or more propulsion units are configured to provide sufficient lift when operating to allow the body to fly;
a flight controller disposed on the body that comprises (1) a transmitter/receiver for transmission to and receipt of data from a remote source, and (2) a memory configured to store at least one flight plan, wherein the flight controller is configured to autonomously control the one or more propulsion units as a function of the stored flight plan and fly the drone from a first, initial position to a second position;
an insect trap coupled to the body, wherein the insect trap comprises an ingress leading to a funnel that leads to a container, wherein the funnel is sized and dimensioned to allow one-way movement of an insect into the container via the funnel;
titanium dioxide (TiO₂) disposed within the container in the insect trap, wherein the TiO₂ comprises a powder contained within a mesh bag;
at least one ultraviolet (UV) light source configured to emit UV light on the TiO₂ to produce carbon dioxide (CO₂); and
a solar panel disposed on the body and configured to provide power to at least one of a battery coupled to the body and the at least one UV light source.

2. The drone of claim 1, wherein the TiO₂ is also disposed on the funnel.

3. The drone of claim 1, wherein the at least one UV light source is disposed within the insect trap and below the funnel.

4. The drone of claim 1, wherein the battery is configured to power the flight controller, the one or more propulsion units, and the at least one UV light source, and wherein the solar panel is configured to charge the battery.

5. The drone of claim 4, wherein the battery comprises a storage capacity of between 4,000-6,000 mAh.

6. The drone of claim 1, wherein the ingress comprises a grate sized and dimensioned to permit entry into the insect trap of the insect.

7. The drone of claim 1, wherein the insect is a mosquito.

8. The drone of claim 1, wherein the drone comprises four propulsion units, wherein two of the propulsion units are configured to rotate their respective propellers clockwise, with the other two propulsion units configured to rotate their respective propellers counter-clockwise, to thereby allow directional control of the drone.

9. The drone of claim 1, further comprising a video camera and a GPS unit.

10. The drone of claim 1, wherein the solar panels are configured to provide power to and recharge the battery.

11. The drone of claim 1, wherein the body comprises a carbon fiber frame.

12. The drone of claim 1, wherein the battery is configured to provide power sufficient to permit the drone to take-off from the first position, fly a distance of at least 5 miles and then land at the second position according to the stored flight plan, and wherein the solar panels are configured to recharge the battery to permit the drone to return to the first position from the second position.
